(19) United States
(12) Patent Application Publication
(10) Pub. No.: US 2015/0348216 A1
(43) Pub. Date: Dec. 3, 2015

(54) INFLUENCER ANALYZER PLATFORM FOR SOCIAL AND TRADITIONAL MEDIA DOCUMENT AUTHORS

(71) Applicant: General Electric Company, Schenectady, NY (US)

(72) Inventors: Steven Matt Gustafson, Niskayuna, NY (US); Dongrui Wu, Niskayuna, NY (US)

(73) Assignee: General Electric Company, Schenectady, NY (US)

(21) Appl. No.: 14/290,429

(22) Filed: May 29, 2014

(51) Int. Cl. G06Q 50/00; G06F 17/30; G06Q 30/02

(52) U.S. Cl. CPC G06Q 50/01; G06Q 30/0201; G06F 17/30864

(57) ABSTRACT

According to some embodiments, an influencer analyzer platform may access a document database storing documents associated with various social and traditional media sources, each document being associated with an author. A first influencer score may be calculated for a selected author based on a first algorithm and the documents in the document database. Similarly, a second influencer score may be calculated for the selected author based on a second algorithm, different than the first algorithm, and the documents in the document database. An overall influencer score may then be calculated based on the first influencer score adjusted by a first weighing value and the second influencer score adjusted by a second weighing value.

### BACKGROUND

In some cases, an entity, such as a corporation, may be interested in determining the overall influence of an author who publishes documents via social and/or traditional media outlets. Some authors may, for example, have a substantial influence over the public's perception of company or of a product or service it provides. For example, an author's influence over the quantity and/or tone of public discussion associated with an entity on social media, social networking, traditional media and other online sites and data repositories (referred to herein as “media sources”) may be of particular interest. As used herein, the term “social media” may refer to any web site, web application, online data repository, or online media outlet wherein members of the public share and/or exchange information with other people. By way of examples only, social media sources might include social networking sites, Facebook®, Twitter®, Instagram®, Tumblr®, MySpace®, personal and organizational blogs, chat rooms, YouTube®, and other public online collaborative media.

The amount of such information, including information available via social networking webs on the Internet, can be vast. Moreover, there are many different types of information sources and authors that may be of interest. As a result, monitoring, tracking, and mining this data can be a time consuming, expensive, error-prone, and difficult task. In addition, the results of such monitoring can include a confusing amount and array of information that can be difficult to comprehend, analyze, evaluate, correlate and/or act upon. For example, it might be difficult to understand which authors are able to immediately generate a lot of attention for a product or service.

### SUMMARY

According to some embodiments, an influencer analyzer platform may access a document database storing documents associated with various social and traditional media sources, each document being associated with an author. A first influencer score may be calculated for a selected author based on a first algorithm and the documents in the document database. Similarly, a second influencer score may be calculated for the selected author based on a second algorithm, different than the first algorithm, and the documents in the document database. An overall influencer score may then be calculated based on the first influencer score adjusted by a first weighing value and the second influencer score adjusted by a second weighing value

Other embodiments may include: means for accessing, by an influencer analyzer platform, a document database storing a plurality of documents associated with a plurality of social and traditional media sources, each document being associated with an author; for a selected author, means for calculating a first influencer score based on a first algorithm and the documents in the document database that are associated with the selected author; means for calculating a second influencer score for the selected author based on a second algorithm, different than the first algorithm, and the documents in the document database that are associated with the selected author; means for calculating an overall influencer score based on the first influencer score adjusted by a first weighing value and the second influencer score adjusted by a second weighing value; and means for outputting an indication of the overall influence score.

A technical effect of some embodiments of the invention is an improved and automated ability to interpret information about authors associated with social and traditional media sources. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block level diagram of a system according to some embodiments.

FIG. 2 illustrates a method according to some embodiments of the present invention.

FIG. 3 is a tabular view of a portion of a document database in accordance with some embodiments of the present invention.

FIG. 4 is a tabular view of a portion of an influencer result database in accordance with some embodiments of the present invention.

FIG. 5 illustrates an information flow according to some embodiments of the present invention.

FIG. 6 is a block diagram of a system in accordance with some embodiments.

FIG. 7 illustrates a display that might be associated with a user alert in accordance with some embodiments.

FIG. 8 is a block diagram of an influencer analyzer apparatus in accordance with some embodiments of the present invention.

FIG. 9 is a tabular view of a portion of an influencer database in accordance with some embodiments of the present invention.

FIG. 10 is a tabular view of a portion of an overall results database in accordance with some embodiments of the present invention.

FIG. 11 illustrates a search display in accordance with some embodiments.

### DETAILED DESCRIPTION

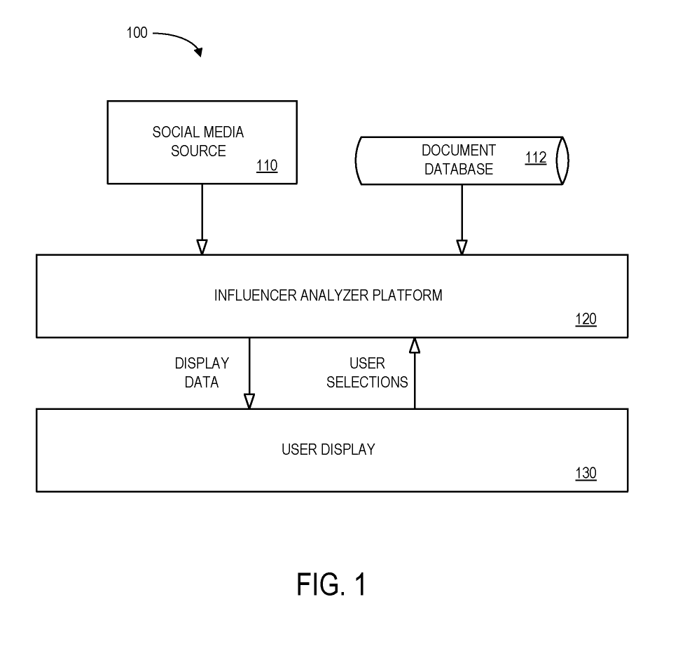

To address some of the problems described in the background section of this application, an influencer analyzer application and/or apparatus may be provided. For example, FIG. 1 is block diagram of a system 100 in accordance with some embodiments. In particular, an influencer analyzer tool or platform 120 may receive information from a number of remote social media sources 110 and/or a document database 112 (including, for example, data associated with social networking sites). The influencer analyzer platform 120 may also exchange data with one or more remote user displays 130. As used herein, a device may be “remote” from the influencer analyzer platform 120 in that it is physically located distant from the influencer analyzer platform 120 and/or in that it communicates with the influencer analyzer platform 120 via one or more Internet and/or intranet communication networks and/or protocols. The influencer analyzer platform 120, social media sources 110, document database 112, and user display 130 may then operate in accordance with any of the embodiments described herein.

According to some embodiments, the influencer analyzer platform 120, social media sources 110, document database 112, and user display 130 facilitate an automated transfer of information associated with one or more social media sources. As used herein the term “automated” indicates that at least some part of a step associated with a process or service is performed with little or no human intervention. By way of examples only, the social media sources 110, document database 112, and/or user display 130 might be associated with a Personal Computer (PC), a notebook computer, a server, an Internet data “cloud”, a workstation, and/or a Personal Digital Assistant (PDA). The influencer analyzer platform 120 might be associated with, for example, a server, an enterprise application, and/or a database.

Note that the social media sources 110 and document database 112 might be associated with either the social media source web site or a third-party service that collects information (such as Omniture®, Meltwater®, Radian6®, Google Analytics®, Factiva®, and other private, proprietary collaborative and analytical media systems). According to some embodiments, information is collected from social media sources 110 and/or traditional media sources and stored in the document database 112.

Any of the devices described in connection with the system 100 might, according to some embodiments, exchange information via a communication network and use specific communication network protocols. As used herein, devices (including those associated with the influencer analyzer platform 120, social media sources 110, document database 112, and user display 130) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, an Ethernet network, a wireless LAN network, a mobile/cellular network (GSM, GPRS, EDGE, etc), a WiMAX network, a satellite network (e.g., CDMA, FDMA, etc), and/or an Internet Protocol (TCP/IP) network such as the Internet, an intranet, an extranet. Note that any devices described herein may communicate via one or more such communication networks.

The devices of FIG. 1 might, according to some embodiments, be accessible via a Graphical User Interface (GUI). The GUI might be associated with a data exchange layer application and may be used, for example, to dynamically display and receive information in connection with social media sources 110, the document database 112, a configuration of business systems, the influencer analyzer platform 120, and/or the user display 130.

Although a single influencer analyzer platform 120 and user display 130 are shown in FIG. 1, any number of such devices and systems may be included. Moreover, various devices described herein might be combined or co-located according to embodiments of the present invention.

The influencer analyzer platform 120 may include a communication device (e.g., a port) to receive data from the plurality of social media sources 110, document database 112, and/or the user display 130. The influencer analyzer platform 120 may further include a processor coupled to the communication device and a storage device in communication with the processor storing instructions adapted to be executed by the processor to perform a method in accordance with any of the embodiments described herein. For example, the influencer analyzer platform 120 may aggregate and/or store information that is received from the social media sources 110 and document database 112. The influencer analyzer platform 120 may also receive user selections from the user display 130 (e.g., his or her display preferences) and transmit display data to the user display 130. For example, a user might adjust or select algorithms associated with the influencer analyzer platform.

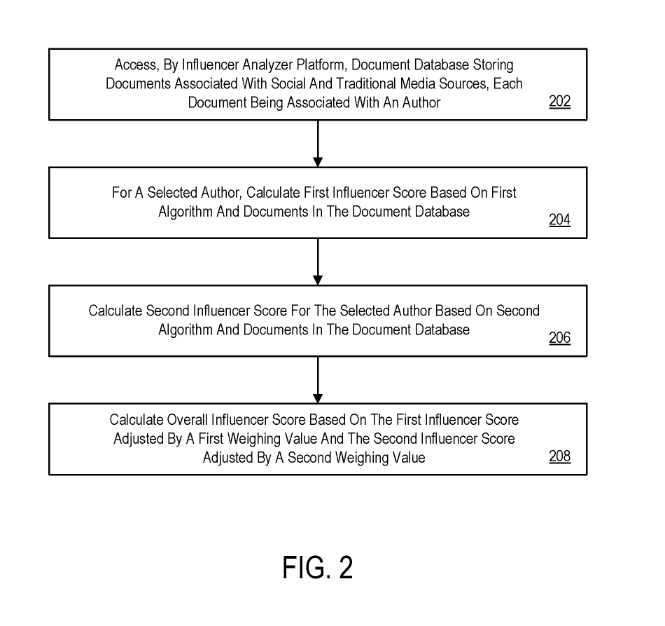

FIG. 2 illustrates one method that might be performed, for example, by the influencer analyzer platform 120 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, a document database storing a plurality of documents published via a plurality of social and/or traditional media sources, each document being associated with an author, may be accessed by an influencer analyzer platform. As used herein, the term “author” may refer to, for example, a publisher entity (e.g., the Associated Press®) and/or an individual. Moreover, the term “document” might refer to, for example, a formal news publication, a formal press release, a research article, social network posts, social network updates, blog entries, user comments, links, and/or web pages. Note that a document might comprise text, images, audio information, and/or video information.

At 204, for a selected author, a first influencer score may be calculated based on a first algorithm and the documents in the document database associated with the selected author. As used herein, the term “selected author” may refer to, for example, an author selected by a user or by the influencer analyzer platform (e.g., it may sequentially select each individual author in the document database until all authors have been processed). Similarly, at 206, a second influencer score may be calculated for the selected author based on a second algorithm (e.g., different than the first algorithm) and the documents in the document database associated with the selected author.

By way of example, the algorithms at 204 might comprise determining a total number of documents published by the selected author in a pre-determined time period (e.g., during a particular on-line campaign, during the last 60 days, etc.). As other examples, the algorithms might be associated with a number of positive documents and/or a number of negative documents (e.g., as automatically determined by a natural language scanning engine). As still other examples, the algorithms might determine “entropy” of document distribution published by the selected author. That is, an author who publishes at a consistent and steady rate may have lower entropy as compared to an author who publishes in bursts. According to some embodiments, the algorithms may be associated with determining an impact of documents published by the selected author over one or more subsequent pre-determined periods of time (e.g., one or three days after the selected author published his or her document). Note that the algorithms may be, in some embodiments, based on information received from a third party (e.g., such as information associated with Klout, Kred or top tier weight).

At 208, an overall influencer score may be calculated based on the first influencer score adjusted by a first weighing value and the second influencer score adjusted by a second weighing value. For example, the influencer analyzer platform might calculate:

OverallScore=(FirstScore*w₁)+(SecondScore*w₂)

where w₁ and w₂ represent the first and second weighing values, respectively. According to some embodiments, the influencer analyzer may then output an indication of the overall influence score (e.g., by displaying a ranked list of authors, generating a report, etc.). Although two weighing values are described for simplicity, note that embodiments may be associated with more weighing values.

Note that in a measurement space, it may be difficult to directly capture a concept like “influence.” According to some embodiments described herein, having multiple measures (that may hopefully be “independent” in their sources of data and error) may be advantageous. Some embodiments described herein explicitly look for “weak” indicators that are much more likely to be independent, and thus more likely to be combined in a meaningful way to capture the underlying concept of “influencer” better.

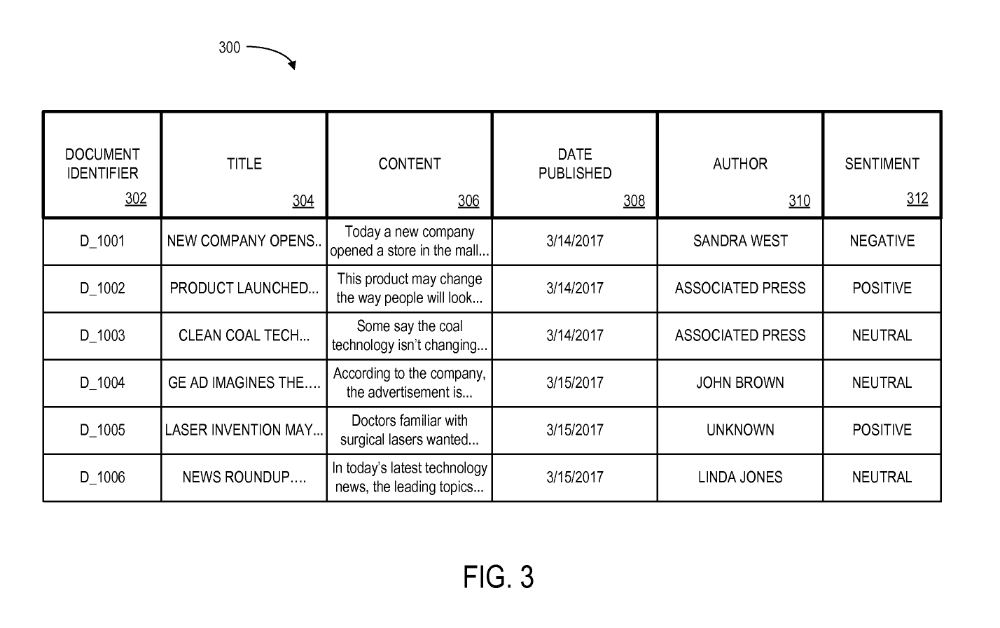

By way of example, FIG. 3 is a tabular view of a portion of a document database 300 in accordance with some embodiments of the present invention. The table includes entries associated with documents. The table also defines fields 302, 304, 306, 308, 310, 312 for each of the entries. The fields specify: a document identifier 302, a title 304, content 306, a date published 308, an author 310, and sentiment information 312. The information in the database 300 may be periodically created and updated based on information received from remote traditional and/or social media sources.

The document identifier 302 might, for example, be a unique alphanumeric code that identifies a document. The title 304 might comprise the document's title or heading, and the content 306 might include the text of the document or a point to where the text is stored. The date published 308 may indicate when the author published the article. The author 310 might indicate who wrote the document. Note that when the author is unknown (e.g., as with “D_1005”), the associated document might be ignored with respect to influencer analysis. The sentiment 312 might indicate, for example, that the document is mainly positive, negative, or neutral.

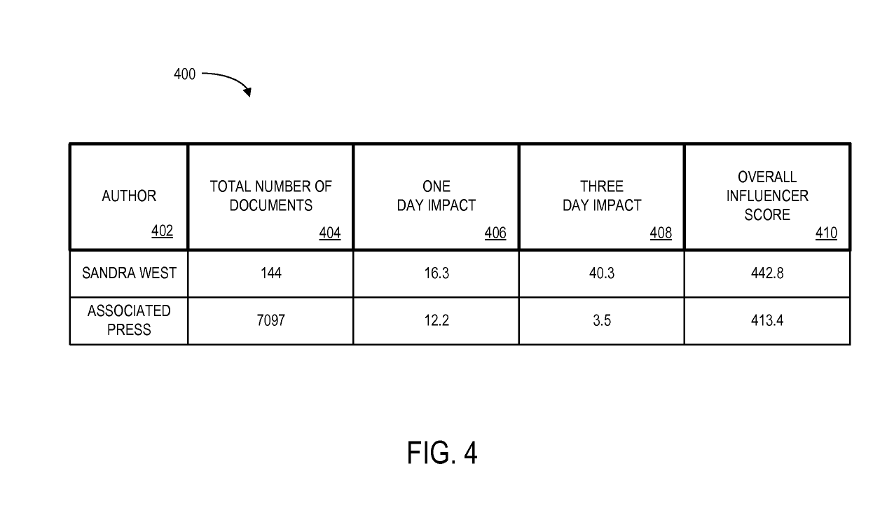

FIG. 4 is a tabular view of a portion of an influencer result database in accordance with some embodiments of the present invention. In this example, for each author 402, three influencer scores have been calculated: a total number of documents 404, a one day impact 408, and a three day impact 408. The three day impact 408 might be computed, for example, by considering a document's date of publication to be “D0.” The total number of documents on days D1 through D3 divided by the number of documents on day D0, divided by the number of documents by the selected author on day D0 and averaged across all of the days in the time period may comprises the three day impact 408. Moreover, an overall influencer score 410 may be calculated using the following weighing factors (as illustrated in FIG. 4):

Overall=(0.05*TotalDocuments)+(2*1DayImpact)+(10*3DayImpact)

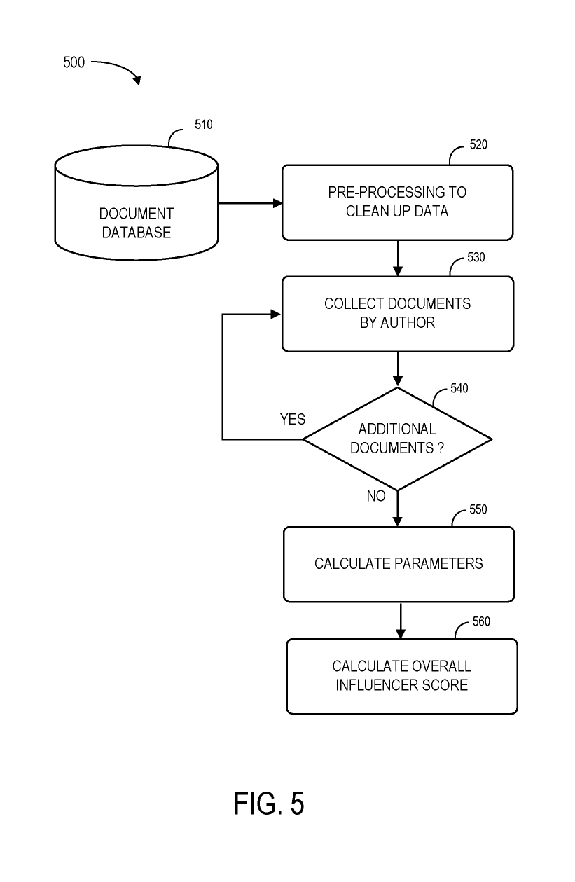

FIG. 5 illustrates an information flow 500 according to some embodiments of the present invention. Information in a document database 510 may pass through a pre-processing element to clean the data. For example, an author name of “A.P.” Might be converted to “Associated Press” so that all of the articles published by the Associated Press may be identified as originating from a single source. Similarly, all text might be converted to lower case, nicknames might be replaced, etc. At 530, documents are collected for each selected author until there are no more documents for that author at 540. The individual parameters may be calculated at 550 (e.g., representing weak influencer indicators) and those parameters may be weighted and combined to calculate an overall influencer score at 560.

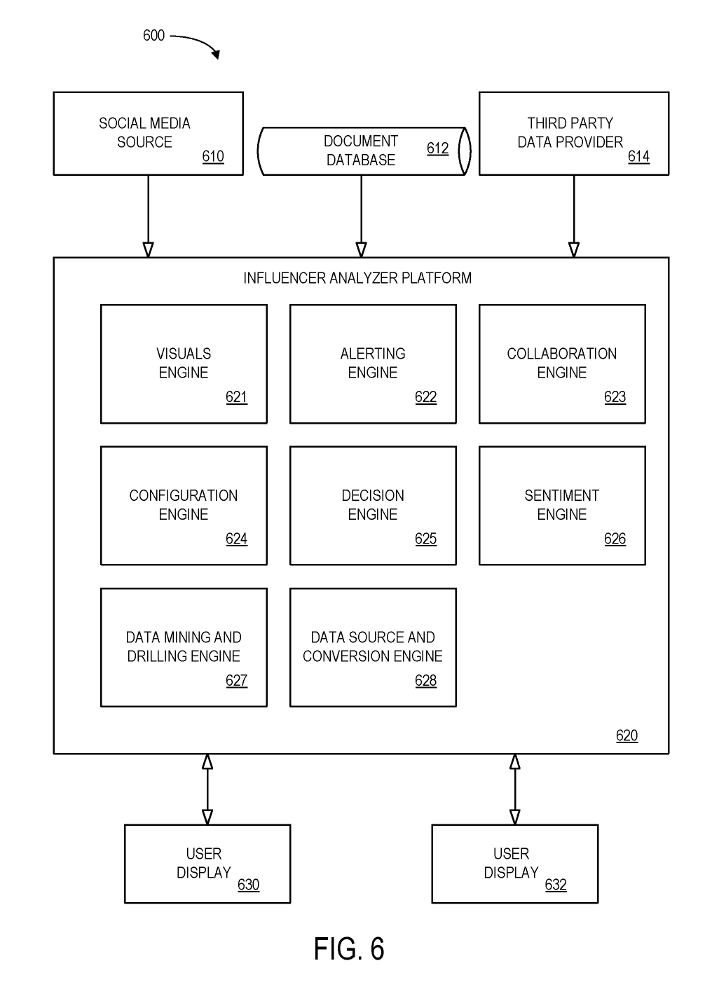

FIG. 6 is a block diagram of a system 600 in accordance with some embodiments. In particular, the influencer analyzer apparatus 620 may receive information from social media sources 610, a document database 612 as well as other third party data providers 614 (e.g., which may rank authors or documents in various ways). The influencer analyzer apparatus 620 may then arrange for appropriate displays to be provided for a number of different user displays 630, 632.

The influencer analyzer apparatus 620 may include a visuals engine 621 to provide data visualization over time and across influencer measurements. Each measurement might appear in different shapes, sizes, and/or colors to not only clearly distinguish it from other measurements, but to also provide an intuitive description of magnitude, duration, frequency and/or trend. The visuals engine 621 may, for example, be capable of clearly overlaying multiple influencer measurements in one screen for any time period. It may also able to zoom in and out across different time scales simply by double-clicking on the area of interest.

Besides the visualization of author influence, the visuals engine 621 may help enables in-depth data review for various social media aspects, such as viewing YouTube® videos of a specific campaign, reading commentary from Twitter® members over smart-grid technology, viewing total press releases on a given day, reviewing in-depth articles from Factiva®, etc. The visuals engine 621 might help provide a linkage between an in-depth source and an overall influencer trend and timeframe. Note that an open and modular aspect of the visuals engine 621 may help turn on and off combinations of different visualizations to improve readability and understanding.

The influencer analyzer apparatus 620 may also include a configuration engine 624, such as a flexible management and/or configuration component that lets users save preferences and administrators manage roles and security. A user might, for example, save his or her preferences for influencer visualizations and/or add and remove events, publications, and campaigns. Administrators might fine-tune security by managing user roles. According to some embodiments, the configuration engine 624 may be integrated with other organizational directory systems.

The influencer analyzer apparatus 620 may also include an alerting engine 622 that works together with a decision engine 625 to alert interested users to specific influencer trends and user-defined changes in influencer measurements. It may be capable of sending alerts using various mediums, such as email, desktop alerts, and instant messaging. The decision engine 625 may provide statistical analysis of influencer measurements, and the user might be able to define and set alerts for specific statistical trends within and between influencer measurements.

The influencer analyzer apparatus 620 may also include a collaboration engine 623 coupled to the visuals engine 621, alerting engine 622, and/or decision engine 625 to provide cross-organization collaboration on influencer trends, data, and commentary. Users might, for example, send exact influencer visualizations to another user, define a start and end of a campaign, and/or insert commentary on an influencer measurement associated with a timeframe.

The influencer analyzer apparatus 620 may also include a sentiment engine 626 coupled to the visuals engine 621, alerting engine 622, and/or decision engine 625 to provide sentiment analysis from multiple documents, and/or to leverage weighting and viewership to further refine the “priorities” of different sentiments.

The influencer analyzer apparatus 620 may also include a data mining and drilling engine 627 coupled to the visuals engine 621 to provide in-depth data sources for influencer trends (tying different in-depth sources such as articles to specific trends and timeframes) and/or to provide users an ability to drill down into as much details as desired. The data mining and drilling engine 627 may also provide search functionality to let a user find targeted information about social media terms and/or topics. According to some embodiments, search results may be grouped by different influencer measurements and sources.

The influencer analyzer apparatus 620 may also include a data source and conversion engine 628 to provide a structured document data source framework, to enable users to “plug-in” various sources of data, such as Omniture®, Radian6®, Meltwater®, Google Analytics®, custom press releases, Twitter® commentary, and/or YouTube® traffic reports. According to some embodiment, the apparatus 620 may also cluster authors into distinct types and score them based on their cluster performance. For example, there might be N different types of influence behaviors in a campaign, and there are the individual authors who are diving each of those behaviors.

Thus, some embodiments of the system 600 described herein may help with a number of different business, communications, and/or marketing challenges for an organization. For example, the system 600 may help evaluate the effectiveness of marketing and communications campaigns of a company and help executives understand influences and trends (including micro, macro and anomalous trends) regarding a company. The system 600 may also help enable cross-organization collaboration with influential authors, communications and marketing campaigns for a company, and/or help obtain competitive analysis of similar companies (from a traditional and social media perspective). The system 600 may let a user see the “big picture” and provide in-depth drill-down influencer measurements, reports, and data for a company to help the user reach out to and/or respond to influential authors regarding a company over specific campaigns, advertising, technology, and/or actions. The system 600 may further let a user obtain rapid alerts of statistically significant changes in the influencer landscape through email, Short Message Service (“SMS”) text, Multimedia Messaging Services (“MMS”), instant messaging, blog posts, Twitter posts, and/or desktop notification mediums. Moreover, the system 600 may help a user understand different degrees of “importance” and “impact-level” assigned to different authors as he or she views information from a combination of diverse sources, rather than a single source.

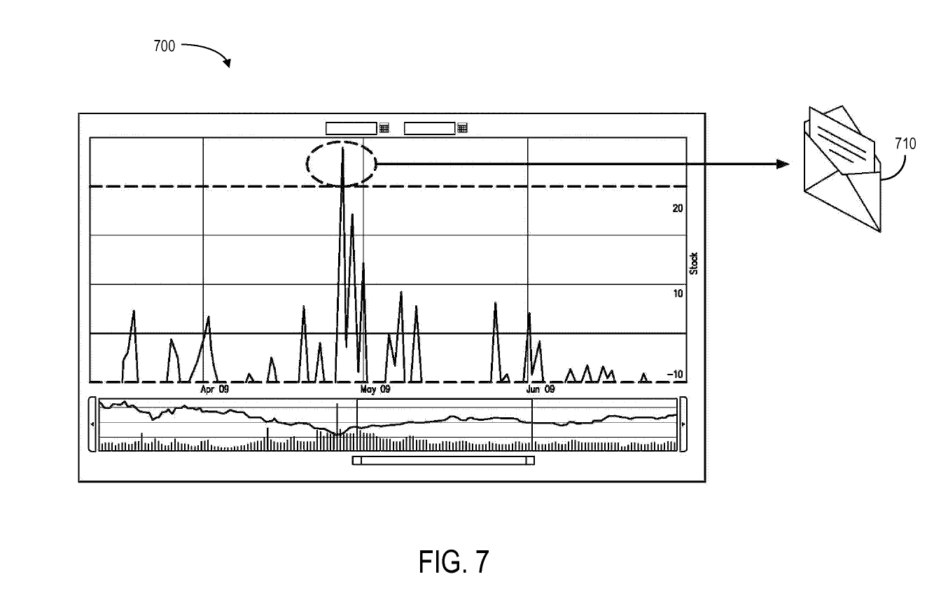

Note that a user might be interested in knowing (in substantially real time) if and when certain influencer parameters exceed (or fall below) a threshold value. According to some embodiments, an alert is automatically transmitted when an influencer data parameter exceeds a user-defined threshold (e.g., when a particular author's overall influence score is fifty percent higher than average). FIG. 7 illustrates a display 700 that might be associated with a user alert 710 in accordance with some embodiments. For example, an influencer analyzer platform might provide user boundary anomaly detection wherein user sets upper and lower boundaries for any measurement. When that measurement crosses the boundaries for D consecutive (or total number of) documents or days, an alert might be transmitted to the user. As another example, the influencer analyzer platform might provide moving average anomaly detection wherein a user sets moving average on any measurement. If that measurement is above (or below) the moving average by P percentage, an alert might be transmitted to the user. The display 700 may also let a user detect or manually associating at least one “event” within a pre-determined period of time. The event might be associated with, for example, a press release, a news story, a web cast, a financial report, a trade show, and/or a public figure (e.g., when the president of the United States visits a particular factory).

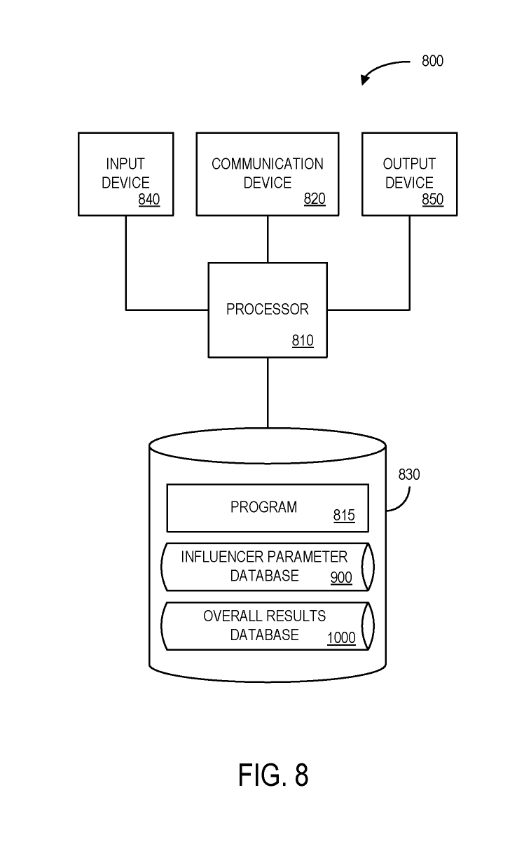

FIG. 8 is a block diagram of an influencer analyzer apparatus 800 in accordance with some embodiments of the present invention. The apparatus 800 might, for example, comprise a platform or engine similar to the influencer analyzer platform 120 illustrated in FIG. 1. The apparatus 800 comprises a processor 810, such as (but in no way limited to) one or more INTEL® Pentium® processors, coupled to a communication device 820 configured to communicate via a communication network (not shown in FIG. 8). The communication device 820 may be used to exchange information with remote document databases and/or display devices.

The processor 810 is also in communication with an input device 840. The input device 840 may comprise, for example, a keyboard, a mouse, or computer media reader. Such an input device 840 may be used, for example, to enter configuration and/or management information about user influence analysis preferences. The processor 810 is also in communication with an output device 850. The output device 850 may comprise, for example, a display screen or printer. Such an output device 850 may be used, for example, to provide reports and/or display information associated with influence analysis.

The processor 810 is also in communication with a storage device 830. The storage device 830 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 830 stores a program 815 for controlling the processor 810. The processor 810 performs instructions of the program 815, and thereby operates in accordance any embodiments of the present invention described herein. For example, the processor 810 may access a document database storing documents associated with various social and traditional media sources, each document being associated with an author. A first influencer score may be calculated by the processor 810 for a selected author based on a first algorithm and the documents in the document database. Similarly, a second influencer score may be calculated by the processor 810 for the selected author based on a second algorithm, different than the first algorithm, and the documents in the document database. An overall influencer score may then be calculated by the processor 810 based on the first influencer score adjusted by a first weighing value and the second influencer score adjusted by a second weighing value.

As used herein, information may be “received” by or “transmitted” to, for example: (i) the influencer analyzer apparatus 800 from other devices; or (ii) a software application or module within the influencer analyzer apparatus 800 from another software application, module, or any other source.

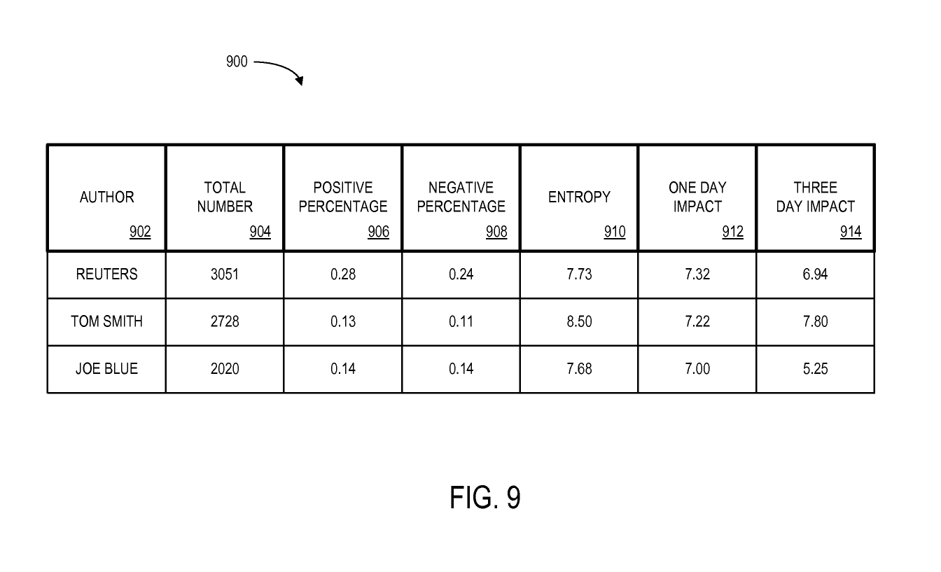

As shown in FIG. 8, the storage device 830 also stores an influence parameter database 900 and an overall results database 1000. One example of such databases 900, 1000 that may be used in connection with the influencer analyzer apparatus 800 will now be described in detail with respect to FIG. 9. The illustration and accompanying descriptions of the databases presented herein are exemplary, and any number of other database arrangements could be employed besides those suggested by the figures. For example, different databases associated with different types of traditional and social media sources might be stored at the apparatus 800.

FIG. 9 is a tabular view of a portion of the influence parameter database 900 in accordance with some embodiments of the present invention. The table includes entries associated with authors. The table also defines fields 902, 904, 906, 908, 910, 912, 914 for each of the entries. The fields specify: an author 902, a total number 904, a positive percentage 906, a negative percentage, entropy 910, a one day impact 912, and a three day impact 914. The information in the influence parameter database 900 may be periodically created and updated based on information received from remote traditional and social media sources and/or a document database.

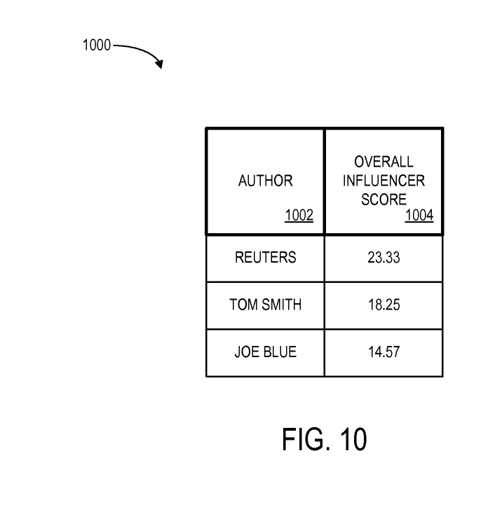

The author 902 might represent an entity that wrote or published a document. Although the table 900 illustrated in FIG. 9 might be updated daily, note that any other periods (or asynchronous updates) might be used instead. In this example, for each author 902, six influencer scores have been calculated: the total number of documents 904, the positive percentage 906, the negative percentage 908, the entropy 910, the one day impact 912, and the three day impact 914. The one and three day impacts 912, 914 might be similar to those described with respect to FIG. 4. Moreover, an overall influencer score may be calculated using the following weighing factors to determine “consistent, positive authors with high impact” (as illustrated by the overall influencer score 1004 for each author 1002 in FIG. 10):

| Parameter | Weight |
|---|---|
| Total Number of Documents | 0.001 |
| Positive Percentage | 20 |
| Negative Percentage | −20 |
| Entropy | 1 |
| One Day Impact | .2 |
| Three Day Impact | .1 |

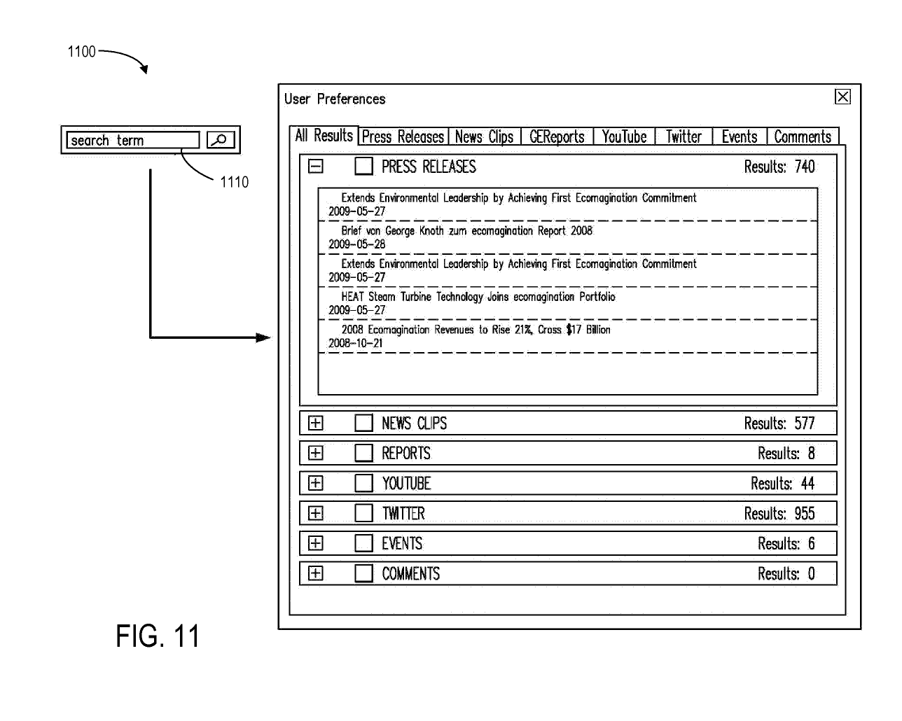

Note that an influencer analyzer platform might provide users access to a vast amount of information. In many cases, however, a user may only be interested in information associated with a particular author, entity, product, or phrase. FIG. 11 illustrates a search display 1100 in accordance with some embodiments. In particular, a user might enter a word or phrase in a search box 1110 and receive a list of search results (e.g., authors or documents) that satisfy his or her query. A user might select one or more of the search results to view an original document.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with social and traditional media sources, although embodiments may be used in connection other types of influencer information, such as by providing visualization, decision making, trend analysis, data mining, and/or comparison capabilities for Information Technology (“IT”), security, sourcing, legal, marketing and finance systems.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An apparatus, comprising:
a document database storing a plurality of documents published via a plurality of social and/or traditional media sources, each document being associated with an author;
a processor coupled to the communication device; and
a storage device in communication with said processor and storing instructions adapted to be executed by said processor to:
for a selected author, calculate a first influencer score based on a first algorithm and the documents in the document database associated with the selected author;
calculate a second influencer score for the selected author based on a second algorithm, different than the first algorithm, and the documents in the document database associated with the selected author;
calculate an overall influencer score based on the first influencer score adjusted by a first weighing value and the second influencer score adjusted by a second weighing value; and
output an indication of the overall influence score.

2. The apparatus of claim 1, wherein the selected author is associated with at least one of: (i) a publisher entity, and (ii) an individual.

3. The apparatus of claim 1, wherein the documents are associated with at least one of: (i) a formal news publication, (ii) a formal press release, (iii) a research article, (iv) social network posts, (v) social network updates, (vi) blog entries, (vii) user comments, (viii) links, and (ix) web pages.

4. The apparatus of claim 1, wherein said calculations are performed for a plurality of selected authors and wherein said processor is further to rank the plurality of selected authors based on the associated overall influencer scores.

5. The apparatus of claim 1, wherein at least one of the algorithms comprise determining a total number of documents published by the selected author in a pre-determined time period.

6. The apparatus of claim 1, wherein at least one of the algorithms is associated with at least one of: (i) a number of positive documents, and (ii) a number of negative documents.

7. The apparatus of claim 1, wherein at least one of the algorithms comprise determining entropy of document distribution published by the selected author.

8. The apparatus of claim 1, wherein at least one of the algorithms comprise determining an impact of documents published by the selected author over a subsequent pre-determined period of time.

9. The apparatus of claim 1, wherein at least one of the algorithms are based on information received from a third party.

10. The apparatus of claim 1, wherein the documents include at least one of: (i) text, (ii) images, (iii) audio information, and (iv) video information.

11. The apparatus of claim 1, associating at least one event within a pre-determined period of time.

12. The apparatus of claim 11, wherein the event is associated with at least one of: (i) a press release, (ii) a news story, (iii) a web cast, (iv) a financial report, (v) a trade show, and (vi) a public figure.

13. The apparatus of claim 1, further comprising at least one of: (i) a dependency graph engine, (ii) a time graph engine, (iii) a table display engine, (iv) a chart engine, (v) a data formatting engine, (vi) a mapping platform, (vii) a visualization engine, (viii) a configuration engine, (ix) a decision engine, (x) a data mining and drilling engine, or (xi) a data source and conversion engine.

14. A computer-implemented method, comprising:
accessing, by an influencer analyzer platform, a document database storing a plurality of documents associated with a plurality of social and traditional media sources, each document being associated with an author;
for a selected author, calculating a first influencer score based on a first algorithm and the documents in the document database that are associated with the selected author;
calculating a second influencer score for the selected author based on a second algorithm, different than the first algorithm, and the documents in the document database that are associated with the selected author;
calculating an overall influencer score based on the first influencer score adjusted by a first weighing value and the second influencer score adjusted by a second weighing value; and
outputting an indication of the overall influence score.

15. The method of claim 14, wherein the selected author is associated with at least one of a publisher entity and an individual, and the documents are associated with at least one of: (i) a formal news publication, (ii) a formal press release, (iii) a research article, (iv) social network posts, (v) social network updates, (vi) blog entries, (vii) user comments, (viii) links, and (ix) web pages.

16. The method of claim 14, wherein said calculations are performed for a plurality of selected authors and wherein said processor is further to rank the plurality of selected authors based on the associated overall influencer scores.

17. The method of claim 14, wherein at least one of the algorithms is associated with at least one of: (i) determining a total number of documents published by the selected author in a pre-determined time period, (ii) a number of positive documents, (iii) a number of negative documents, (iii) determining entropy of document distribution published by the selected author, (iv) determining an impact of documents published by the selected author over a subsequent pre-determined period of time, and (v) information received from a third party.

18. A non-transitory, computer-readable medium storing instructions adapted to be executed by a processor to perform a method, said method comprising:
accessing a document database storing a plurality of documents associated with a plurality of social and traditional media sources, each document being associated with an author;
for a selected author, calculating a first influencer score based on a first algorithm and the documents in the document database that are associated with the selected author;
calculating a second influencer score for the selected author based on a second algorithm, different than the first algorithm, and the documents in the document database that are associated with the selected author;
calculating an overall influencer score based on the first influencer score adjusted by a first weighing value and the second influencer score adjusted by a second weighing value; and
outputting an indication of the overall influence score.

19. The medium of claim 18, wherein the selected author is associated with at least one of a publisher entity and an individual, and the documents are associated with at least one of: (i) a formal news publication, (ii) a formal press release, (iii) a research article, (iv) social network posts, (v) social network updates, (vi) blog entries, (vii) user comments, (viii) links, and (ix) web pages.

20. The medium of claim 18, wherein said calculations are performed for a plurality of selected authors and wherein said processor is further to rank the plurality of selected authors based on the associated overall influencer scores.

21. The medium of claim 18, wherein at least one of the algorithms is associated with at least one of: (i) determining a total number of documents published by the selected author in a pre-determined time period, (ii) a number of positive documents, (iii) a number of negative documents, (iii) determining entropy of document distribution published by the selected author, (iv) determining an impact of documents published by the selected author over a subsequent pre-determined period of time, and (v) information received from a third party.
